(19) United States
(12) Patent Application Publication
(10) Pub. No.: US 2012/0247799 A1
(43) Pub. Date: Oct. 4, 2012

(54) POWER TOOL

(75) Inventors: Shinji HIRABAYASHI, Anjo-shi (JP); Tadasuke MATSUNO, Anjo-shi (JP)

(73) Assignee: MAKITA CORPORATION, Anjo-shi (JP)

(21) Appl. No.: 13/413,151

(22) Filed: Mar. 6, 2012

(30) Foreign Application Priority Data
Mar. 31, 2011 (JP) 2011-078421

(51) Int. Cl. B25F 5/00

(52) U.S. Cl. 173/213

(57) ABSTRACT

Embodiments of the present invention may include a power tool having a driving motor, a continuously variable transmission traction drive, a blast fan and an airflow-guiding structure. The continuously variable transmission traction drive changes number of rotations from the driving motor and outputs the changed number of rotations. The driving motor rotates the blast fan. The blast fan cools the driving motor by sending airflow to the driving motor. The airflow-guiding structure guides the airflow to the continuously variable transmission traction drive.

This application claims priority to Japanese patent application serial number 2011-78421, the contents of which are incorporated herein by reference.

### BACKGROUND OF THE INVENTION

1. Field of the Invention

The present invention relates to a power tool, such as a disc grinder, an electric screwdriver, or a drill for boring, which is equipped with an electric motor therein as a power source.

2. Description of the Related Art

Such a power tool is generally equipped with either a gear train for changing the number of output revolutions of a motor or a gear train for changing the output direction. A CVT (Continuously Variable Transmission) that continuously varies the gear train and reduction ratio is commonly used as a transmission mechanism for power tools. Technology concerning CVT traction drives are disclosed, for example, in JP No. 6-190740 A, JP No. 2002-59370 A, and JP No. 3-73411 B2.

In a continuously variable transmission traction drive, a plurality of conical planetary rollers are supported by a holder. A centrally located sun roller is pressed onto the planetary rollers. A shift ring located around the holder is pressed onto the planetary rollers. Through rolling contact, planetary rollers transmit rotational power to an output shaft. The number of output revolutions is continuously altered due to the changing of the position of the shift ring relative to the planetary rollers. The pressing position of the shift ring pressed to the conical surfaces of the planetary rollers is varied between a small diameter and a large diameter.

A screw-tightening tool equipped with a continuously variable transmission therein is disclosed in JP 6-190740 A. In the screw-tightening tool, it is possible to continuously vary the speed and torque output. This is accomplished by moving a shift ring. In creating low speed/high torque output, thread-fastening can be easily performed.

In the power tools of the related art, such as a screw-tightening tool, it is possible to vary and output the number of revolutions of the driving motor in accordance with the type of work being performed. This is accomplished using a continuously variable transmission traction drive. However, when the power tool is continuously used, the continuously variable transmission traction drive heats up, much like the driving motor. Therefore, a power tool having a structure that can cool the driving motor and the continuously variable transmission traction drive is needed.

### SUMMARY OF THE INVENTION

Certain embodiments of the present invention include a power tool having a driving motor, a continuously variable transmission traction drive, a blast fan and an airflow-guiding structure. The continuously variable transmission traction drive changes the number of rotations from the driving motor and outputs the changed number of rotations. The driving motor rotates the blast fan. The blast fan cools the driving motor by sending airflow to the driving motor. The airflow-guiding structure guides the airflow to the continuously variable transmission traction drive.

In such a configuration, the blast fan can cool the driving motor as well as the continuously variable transmission traction drive.

### BRIEF DESCRIPTION OF THE DRAWINGS

FIG. 1 is a perspective view of an embodiment of a disc grinder;

FIG. 2 is a plain view of the disc grinder of FIG. 1;

FIG. 3 is a cross-sectional view of the inner mechanism of the disc grinder in FIG. 1;

FIG. 4 is a cross-sectional view of a shifting portion taken along line IV-IV in FIG. 3;

FIG. 5 is a cross-sectional view of a shift control portion taken along line V-V in

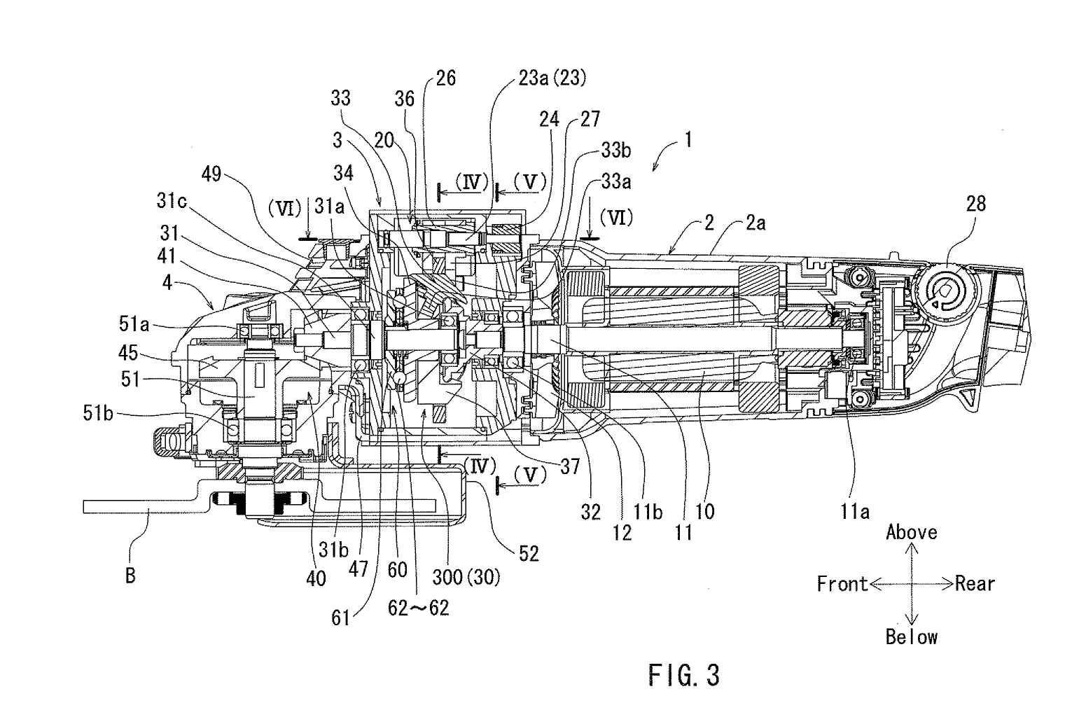

FIG. 3;

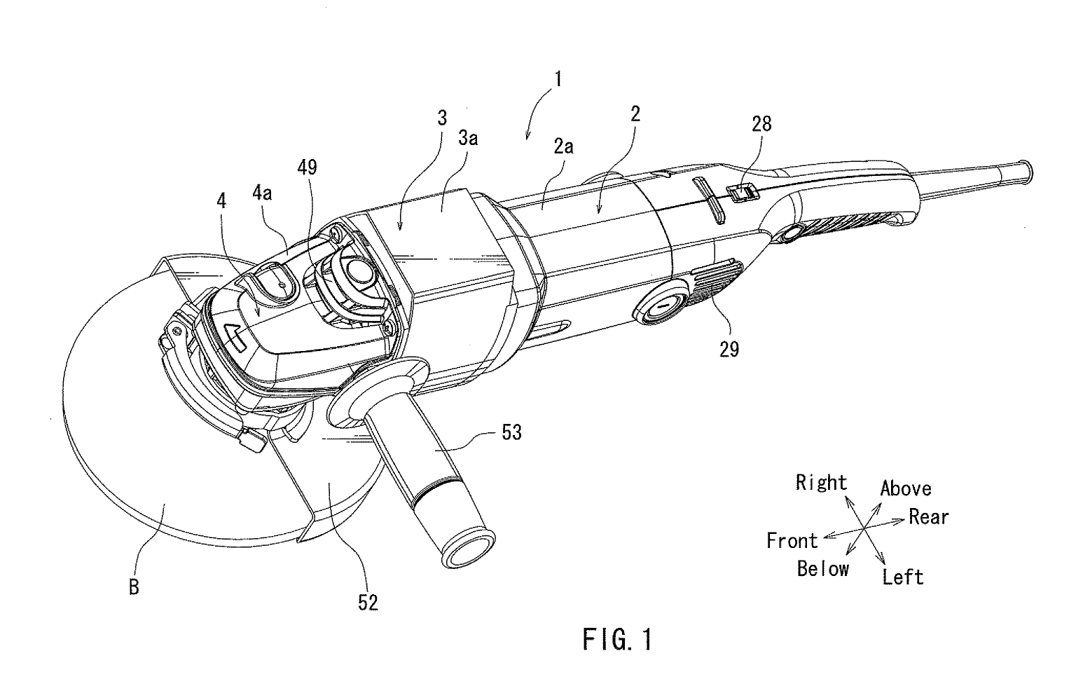

FIG. 6 is a plain view of a front portion of the disc grinder in FIG. 1 showing a cross-sectional view of the shift control position;

FIG. 7 is an enlarged sectional view of the disc grinder for showing an adjusting pressure cam mechanism;

FIG. 8 is a front view of the disc grinder of FIG. 1; and

FIG. 9 is a vertical sectional view of the disc grinder for showing airflow paths of a blast fan.

### DETAILED DESCRIPTION OF THE INVENTION

Each of the additional features and teachings disclosed above and below may be utilized separately or in conjunction with other features and teachings to provide improved power tools. Representative examples of the present invention, which utilize many of these additional features and teachings both separately and in conjunction with one another, will now be described in detail with reference to the attached drawings. This detailed description is merely intended to teach a person of ordinary skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention, Moreover, various features of the representative examples and the dependent claims may be combined in ways that are not specifically enumerated in order to provide additional useful configurations of the present teachings.

A disc grinder 1 is described with reference to FIGS. 1 to 7. The up, down, front, rear, left, and right directions are defined as shown in the figures for easy understanding of the description of the disc grinder 1.

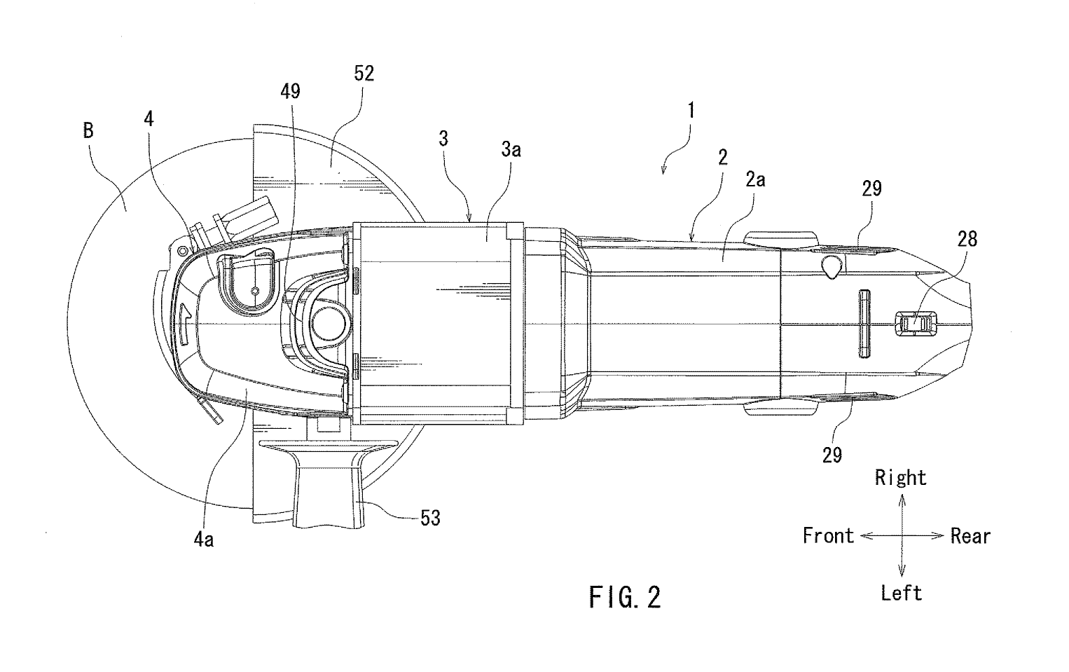

As shown in FIGS. 1 and 2, the disc grinder 101 includes a tool main body 2, a shift portion 3 and a gear head 4. As shown in FIG. 3, an output spindle 51 protrudes downward from the lower end portion of the gear head portion 4. The output spindle 51 outputs rotational power from the reduction unit 40. A circular grindstone B is fitted on the lower end portion of the output spindle 51. A grindstone cover 52 is mounted behind the grindstone B in the lower side portion of the gear head 4. The grindstone cover 52 covers the rear half circumference of the grindstone B to prevent ground dust from being scattered by the grindstone B. As shown in FIG. 1 a side grip 53 may be held by a user during operation. Such a side grip 53 can be placed on the left, right, top, bottom or any other convenient location on the tool. A plurality of side grips 53 may be used.

As shown in FIGS. 1 and 2, the tool main body portion 2 includes a main body case 2a having a cylindrical shape to function as a handle portion that the user holds.

An intake port 29 for suctioning the external air to the tool main body portion 2 by using a blast fan 12 is disposed at the rear portion of the main body case 2a. The intake port 29 is positioned behind a driving motor 10 and has an appropriate slit shape that can suction the external air.

The driving motor 10 is disposed in the main body case 2a, as a driving source. The driving motor 10 is preferably a brush motor that rotates a motor spindle 11. The motor spindle 11 may be rotatably attached to the motor case 2a by bearings 11a and 11b. Further, the blast fan 12 for cooling the motor is attached on the motor spindle 11.

The blast fan 12 may be a centrifugal fan rotated about the motor spindle 11 (rotary shaft) of the driving motor 10. The blast fan 12 sends airflow to the front of the tool main body portion 2 from the rear. Therefore, the internal air pressure of the tool main body portion 2 is typically lower at the portion behind the blast fan 12 in comparison to the portion ahead of the blast fan 12.

Therefore, the external air suctioned from the intake port 29 is sent from the rear portion to the front of the tool main body portion 2. The air flowing inside the tool main body portion 2 is discharged from exhaust ports 47 and 49 (see FIGS. 3 and 9) preferably disposed at a gear head portion 4. The blast fan 12 generates cooling airflow that cools the driving motor 10, in accordance with the rotation of the motor spindle 11.

The motor spindle 111 of the driving motor 110 functions as an output shaft for the driving motor 110 and an input shaft for the continuously variable transmission traction drive 130.

The continuously variable transmission traction drive 30 reduces (shifts) rotation input from the motor spindle 11. The intermediate transmission shaft 31, which functions as an output shaft, outputs the rotation to the reduction unit 40. The intermediate transmission shaft 31 also functions as an input shaft for the reduction unit 40. The rotational force of the reduction unit 40, which is input from the intermediate transmission shaft 31, is reduced by the reduction unit 40 and output through an output spindle 51.

A shifting portion 3 includes a transmission case 3a connected to the front side of the main body case 2a, the continuously variable transmission traction drive 30 is disposed in the transmission case 3a, and a shift control portion 20 for controlling the continuously variable transmission traction drive 30 is disposed in the transmission case 3a. The transmission case 3a corresponds to an outer case which mainly includes the continuously variable transmission traction drive 30 and the shift control portion 120.

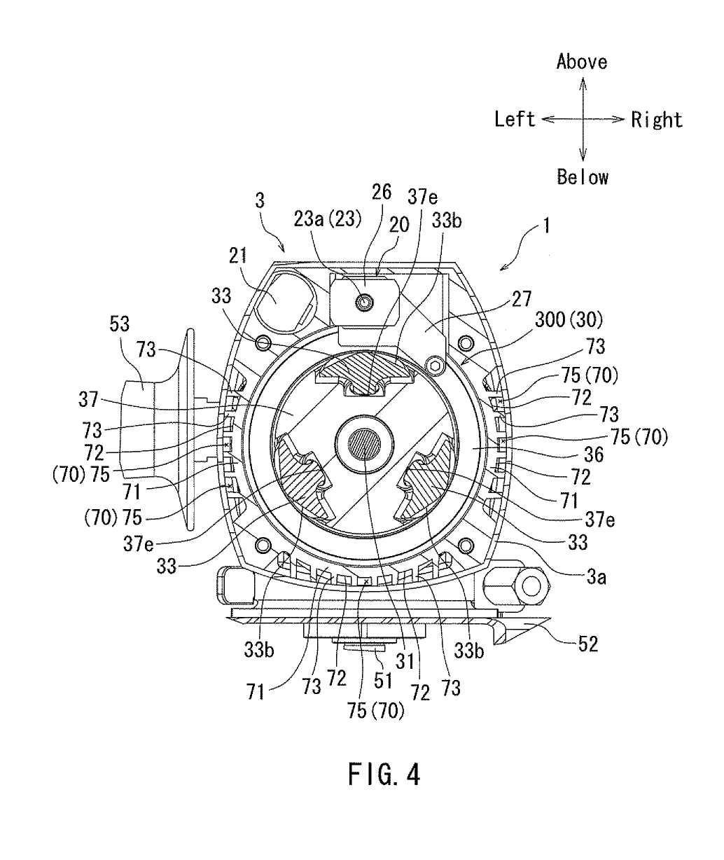

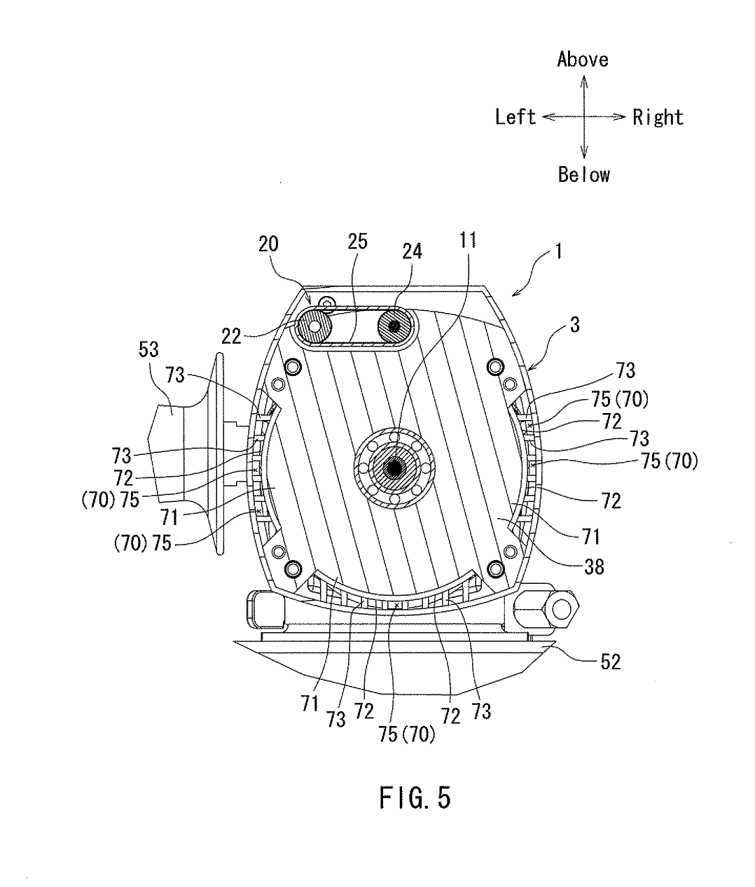

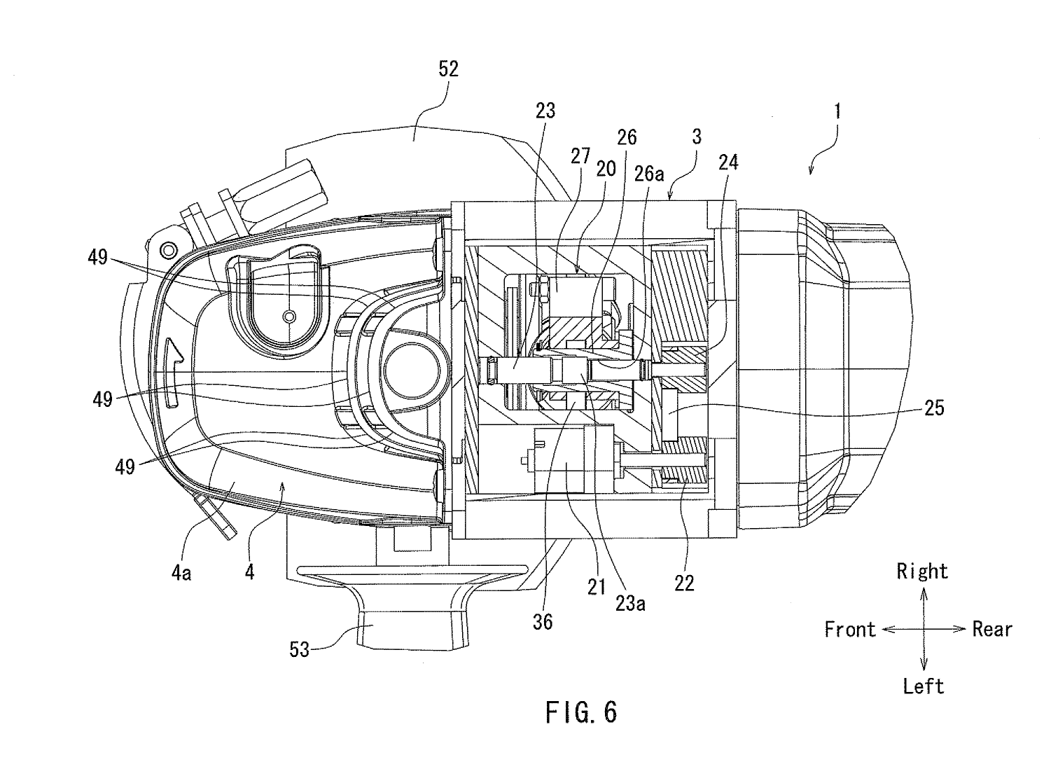

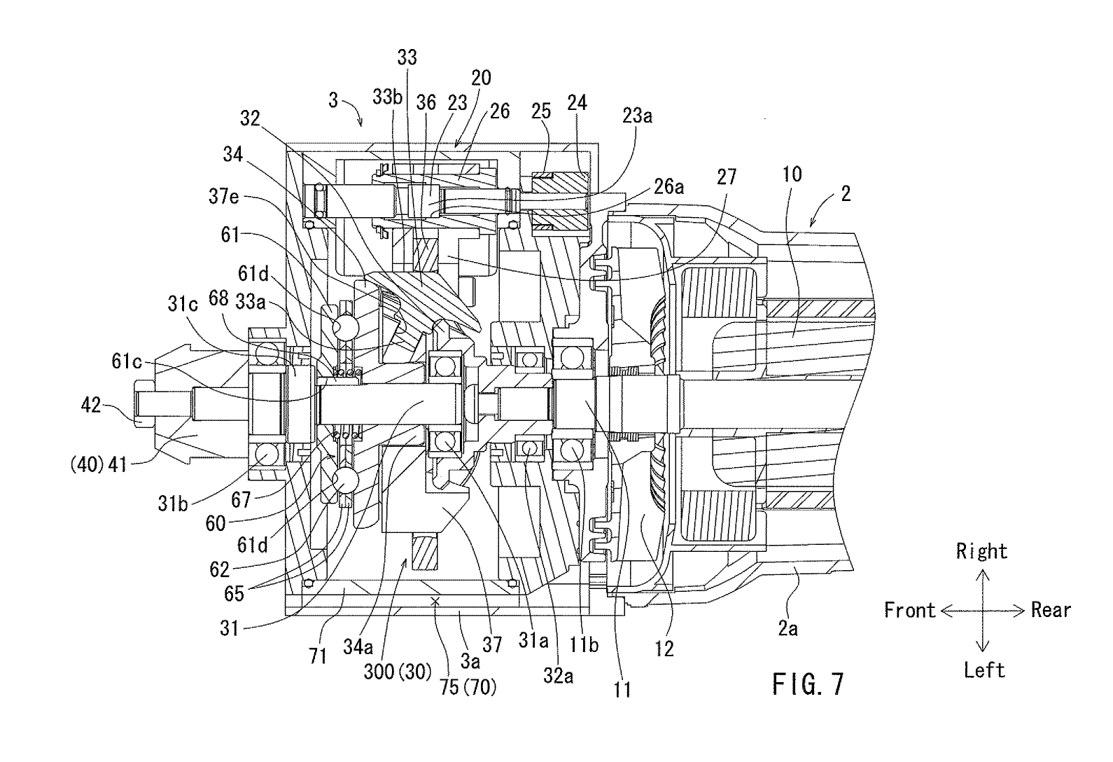

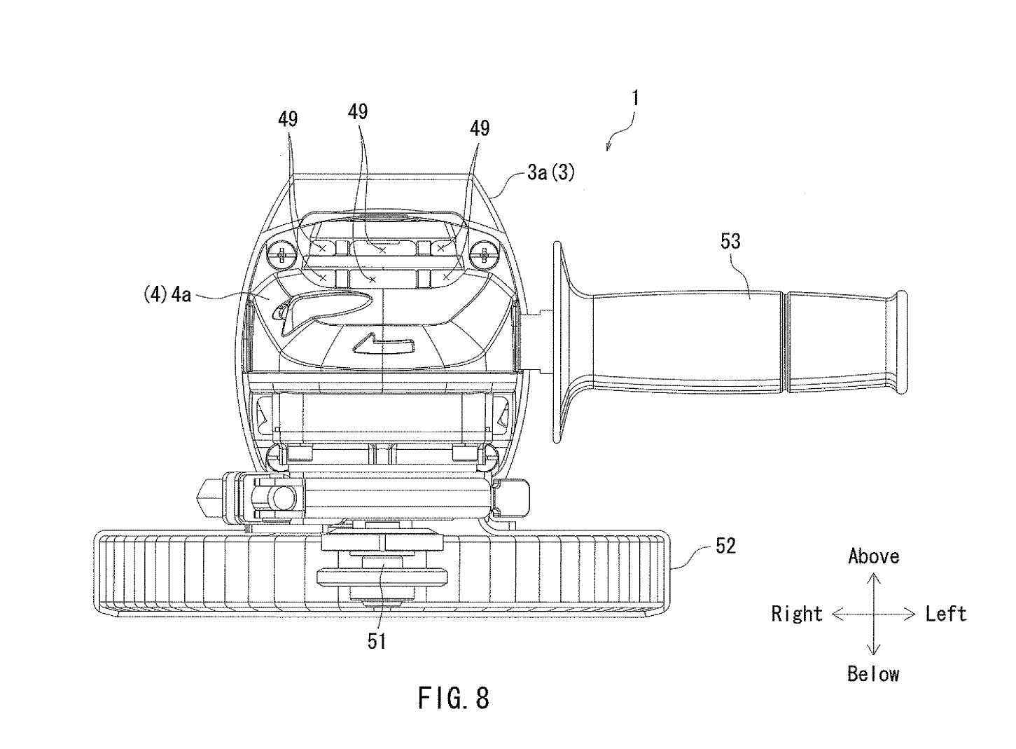

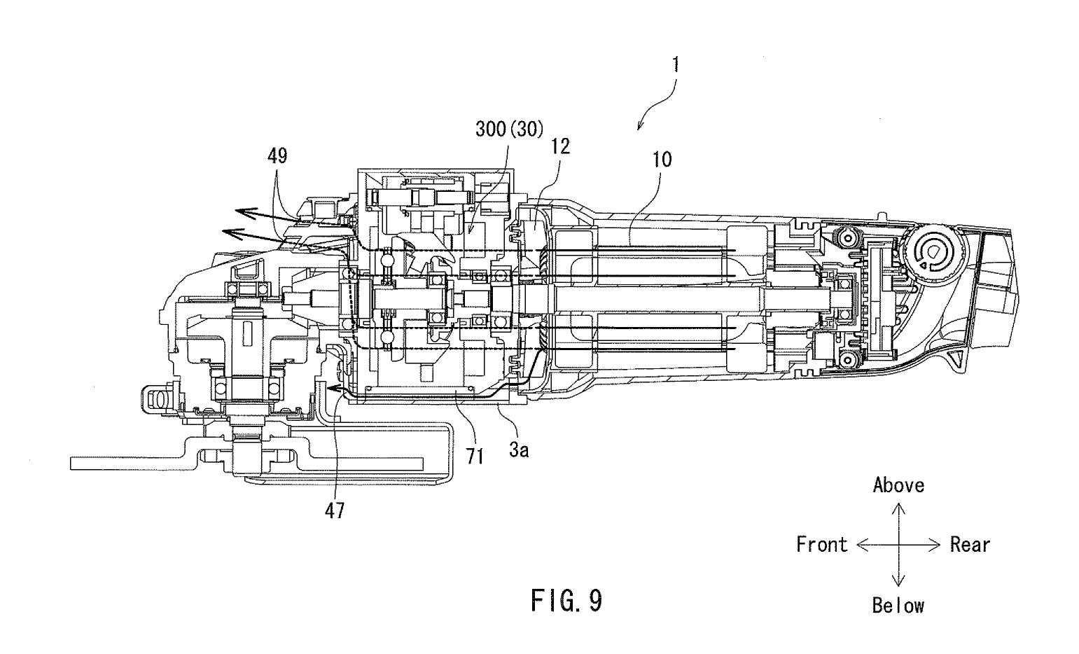

The continuously variable transmission traction drive 30 includes a mechanism main body 300 and an accommodating case 71 that accommodates the mechanism main body 300. The mechanism main body 300 includes a sun roller 32, a planetary roller 33, a push roller 34, a pressure-adjusting cam mechanism 60 (including a pressure-adjusting spring 67), a shift ring 36, a holder 37, and the like, for receiving inputs from the motor spindle 11 and sending outputs to the intermediate transmission shaft 31. The accommodating case 71, as shown in FIGS. 4 and 5, has a hollow cylindrical shape having a closed structure assembled of various members.

The accommodating case 71 is preferably made of metal, such as aluminum. The accommodating case 71 may be covered by the transmission case 3a. The transmission case 3a may be made of a heat-insulating, plastic resin. A plurality of fins 73 protruding outward may be formed at appropriate intervals on the outer surface 72 of the accommodating case 71. The accommodating case 71 may be supported from the transmission case 3a by the plurality of fins 73. The fins 73 function as ribs. Gaps are defined among the accommodating case 71, the transmission case 3a, and the fins 73. The gaps function as ventilation channels 75 and airflow-guiding structures 70 for conveying air sent by the blast fan 12.

The airflow-guiding structure 70 is a structure for cooling the continuously variable transmission traction drive 30 by using the airflow sent by the blast fan 12 to cool the driving motor 10. The airflow-guiding structure 70 includes the ventilation channel 75. A plurality of ventilation channels 75 may be arranged on the left and right sides of the disc grinder 1 and under a transmission portion 3. The ventilation channels 75 are disposed in a generally circular configuration around the generally circular accommodating case 71. A plurality of ventilation channels 75 may be disposed along the circumferential surface. Preferably, the ventilation channels 75 span 180 degrees or more of the 360 degrees of the accommodating case when measured from one starting ventilation channel 75 to an ending ventilation channel 75. The measured distance is a distance that would span every ventilation channel along the circumferential surface of the accommodating case 71. As shown in FIG. 4, a ventilation channel 75 exists on the left side of the figure. Using that as a starting ventilation travel and traveling counter-clockwise in the figure, an ending ventilation channel 75 may be that as shown in the upper right half of the figure. Traveling counter-clockwise, the span covers the ventilation channel 75 shown at the bottom middle location of the figure. This traveled span, from the starting ventilation channel 75 to the ending ventilation channel 75, preferably covers a range of 180 degrees or more of the accommodating case 71. The air passing through the ventilation channels 75 typically comes into contact with the outer surface 72 of the accommodating case 71.

Air is suctioned into the tool main body portion 2 from the intake port 29 by the blast fan 12 and the driving motor 10 is cooled. The air is discharged from a lower exhaust port 47 and an upper exhaust port 49 after passing through the ventilation channels 75 (airflow-guiding structure 70). The lower exhaust port 47 and the upper exhaust port 49 open from the transmission case 3a.

The continuously variable transmission traction drive 30 shifts or reduces the rotation of the motor spindle 11. The continuously variable transmission traction drive 30 preferably uses three pressure points. It may include a sun roller 32 fitted on a motor spindle 11 of the drive motor 10, a plurality of (preferably three) planetary rollers 33 having a conical circumference, a push roller 34 pressed against the planetary rollers 33, a pressure-adjusting mechanism 60 for generating a pushing force to the push roller 34, and a shift ring 36 circumscribed to the conical surface 33b. The planetary rollers 33 are preferably in internal contact with the conical surfaces 33b.

The sun roller 32 is fitted at the front-end portion of the motor spindle 11 of the drive motor 10 to integrally rotate with the motor spindle 11. The sun roller 32 is rotatably supported by the bearing 32a in the transmission case 3a. The sun roller 32 may be pressed against the heads of the planetary rollers 33. The rear side of the intermediate transmission shaft 31 may function as an output shaft. It may be rotatably supported by the bearing 31a mounted on the sun roller 32.

The sun roller 32 and the intermediate transmission roller 31 may be positioned on the same rotational axis as that of the motor spindle 11 of the drive motor 10. The front side of the intermediate transmission shaft 31 may be rotatably supported through a ball bearing 31b. The front portion of the intermediate transmission shaft 31 may extend inside the gear head portion 4.

The three planetary rollers 33 are rotatably supported by the holder 37 by a support shaft portion 33a. Support shaft portions 33a may be inserted in support holes 37e in the holder 37 (see FIG. 4). The planetary roller 33 may be supported with the support shaft portion 33a inclined at a predetermined angle.

The push roller 34 may communicate with the intermediate transmission shaft 31 whereby it can be rotated and axially displaced. The push roller 34 may be pressed to the inner surface of each of the planetary rollers 33. A boss portion 34a formed on the rear surface of the push roller 34 rotatably supports the holder 37 supporting the planetary rollers 33. A pressure-adjusting spring 67 of the pressure-adjusting mechanism 60 may be disposed at the front side of the push roller 34. The pressure-adjusting spring 67 may be a coil spring wound on the outer circumference of the intermediate transmission shaft 131.

The pressure-adjusting spring 35 may be situated between the planetary rollers 33 and the push roller 34. The pressure-adjusting spring 35 may bias the push roller 34 rearward resulting in friction transmission. The drive motor 10 rotates the motor spindle 11 to initially drive the continuously variable transmission traction drive 30.

When the shift ring 36 is positioned at an area on the planetary rollers 33 with a small diameter, the reduction ratio of the continuously variable transmission traction drive 30 is decreased. Therefore, the continuously variable transmission traction drive 30 rotates the intermediate transmission shaft 31 at a high speed toward the output spindle 51. When the shift ring 36 is positioned at an area on the planetary rollers 33 having a large diameter, the reduction ratio of the continuously variable transmission traction drive 30 is increased. Therefore, the continuously variable transmission traction drive 30 rotates the intermediate transmission shaft 31 at a low speed toward the output spindle 51.

The pressure-adjusting cam mechanism 60 is preferably disposed between the continuously variable transmission traction drive 30 and the reduction unit 40. As shown in FIG. 7, the pressure-adjusting can mechanism 60 is positioned ahead of the push roller 34 and behind the reduction unit 40.

The pressure-adjusting cam mechanism 60 may include a plurality of steel balls 62 interposed between the front surface of the push roller 34 and a pressing plate 61. Each of the steel balls 62 is fitted and interposed in cam grooves formed on the front surface of the push roller 34 and the rear surface of the pressing plate 61. The cam grooves preferably have a changing circumferential depth. The pressure-adjusting spring 67 may be disposed between the push roller 34 and the pressing plate 61. The pressing plate 61 is in contact with a stepped portion 31c of the intermediate transmission shaft 31 due to the pressure-adjusting spring 67. In such a way, its axial movement is restricted. A key 68 serves to connect the pressing plate 61 with the intermediate transmission shaft 31 so that they may integrally rotate.

When a rotational load (machining resistance) or the like is exerted on the intermediate transmission shaft 31, relative rotation is generated between the push roller 34 and the pressing plate 61, such that the steel balls 62 are displaced to the shallow sides of the cam grooves. Accordingly, an external force is generated in a direction in which the force pressing the planetary roller 33 to the push roller 34 is increased. The push roller 34 is pressed against the inner surface of the planetary roller 33 by the external force as well as the biasing force of the pressure-adjusting spring 67. As a result, the sun roller 32 is pressed to a neck portion of the planetary roller 33. This same pressing force pushes a transmission ring 36 against the conical surfaces 33b of the planetary rollers 33.

The transmission unit 3 includes a transmission control unit 20 for shifting the continuously variable transmission traction drive 30. The shift control unit 20 is preferably located above the shifting portion 3, on the outer circumference of the shift ring 36. As shown in FIG. 6 the shift control portion 20 includes a shift motor 21, a drive pulley 22 fitted on an output shaft of the shift motor 21, an operation shaft 23 arranged in parallel with the output shaft of the shift motor 21, a receiving pulley 24 fitted on the operation shaft 23, and a drive belt 25 (see FIG. 5) held between the drive pulley 22 and the receiving pulley 24.

When the shift motor 21 starts, the drive belt 25, held between the drive pulley 22 and the receiving pulley 24, moves and the operation shaft 23 rotates about the pivot axis. A threaded portion 23a is formed on the operation shaft 23. An operation sleeve 26 is fitted on the circumference of the operation shaft 23. A threaded hole 26a in the operation sleeve 26 is engaged to the threaded portion 23a of the operation shaft 23. When the operation shaft 23 rotates about the pivot axis, the threaded portion 23a moves while being engaged in the threaded hole 26a, such that the operation sleeve 26 moves in the axial direction (front-rear direction in FIG. 6) of the operation shaft 23.

A bifurcated operation arm 27 may be attached to the operation sleeve 26 in order to prevent movement in the axial direction. The outer portion of the shift ring 36 may be interposed in the bifurcated portion of the operation arm 27. The operation sleeve 26 is moved in the front-rear direction by rotation of the operation shaft 23. The shift ring 36 and planetary rollers 33 preferably lie in parallel and move together towards a low speed side or a high-speed side.

When the shift motor 21 starts to the high-speed side, the shift ring 36 may be moved to the high-speed side (small diameter side) of the planetary rollers 33 by the rotation of the operation shaft 23. Accordingly, the reduction ratio of the continuously variable transmission traction drive 30 decreases. When the shift motor 21 starts to the low speed side, the shift ring 36 is moved to the low speed side (large diameter side) of the planetary rollers 33 by rotation of the operation shaft 23 and the reduction ratio of the continuously variable transmission traction drive 30 increases. A motor control unit, (which is not shown) controls the starting and stopping of the drive motor 10 and the shift motor 21. As shown in FIG. 1, the operation dial 28 may be disposed behind the disc grinder 1. The adjustment of the operation dial 28 serves to control the continuously variable transmission traction drive 30 reduction ratio.

The intermediate transmission shaft 31 serves as an output shaft and an input shaft. It receives rotation from the continuously variable transmission traction drive 30 and transfers it to the reduction unit 40. The intermediate transmission shaft 31 is rotatably supported by two bearings: (1) a ball bearing 31a on the sun roller 32 and (2) a ball bearing 31b in the transmission case 3a.

The gear head portion 4 is preferably located in front of the shift portion 3. The reduction unit 40 is located inside the head case 4a. The output spindle 51 equipped with the grindstone B can protrude downward from the inside of the head case 4a. The head case 4a communicates with the inside of the transmission case 3a.

The reduction unit 40 is an output side gear train on the output side of the continuously variable transmission traction drive 30. The reduction unit 40 serves to convert the rotation from the continuously variable transmission traction drive 30. As shown in FIG. 3, the reduction unit 40 includes a drive gear 41 fitted on the front end of the intermediate transmission shaft 31 by a front clamp 42. It also includes a receiving gear 45 fitted to the base end (upper side) of the output spindle 51.

The output spindle 51 is rotatably supported by bearings 51a and 51b located on the base end side (upper side) and the tip end side (lower side). The bearings 51a and 51b may be fixed to the head case 4a.

The drive gear 41 and the receiving gear 45 may be bevel gears having a conical shape. The drive gear 41 and the receiving gear 45 are engaged by the teeth to transmit rotational motion between two crossing shafts. The drive gear 41 and the receiving gear 45 together constitute a spiral bevel gear (twist bevel gear) transmitting rotational motion between two perpendicular shafts. The drive gear 41 and the receiving gear 45 have engaging teeth to connect with each other during rotation. The number of teeth of the receiving gear 45 is preferably larger than the number of teeth of the drive gear 41. Rotational motion is reduced when rotation is transmitted from the drive gear 41 to the receiving gear 45.

The reduction unit 40 converts the rotation from the intermediate transmission shaft 31 into rotational force in a perpendicular direction. The reduction unit 40 reduces the rotational speed of the intermediate transmission shaft 31. The rotational axis of the intermediate transmission shaft 31 and the rotational axis of the output spindle 51 may be perpendicular to each other.

In a disc grinder 1, the following operation may be accomplished. In the continuously variable transmission traction drive 30, the drive motor 10 rotates the sun roller 32. The sun roller 32 engages the pivot axis to thereby rotate the planetary rollers 33. The planetary rollers 33 revolve around the intermediate transmission shaft 31 due to the planetary rollers 33 being pressed against the shift ring 36. The rotation of the planetary rollers 33 causes rotation of the push roller 34. The push roller 34 integrally rotates with the intermediate transmission shaft 31. The intermediate transmission shaft 31 rotates the output spindle 51 through the reduction unit 40.

Thick line arrows in FIG. 9 show airflow paths generated by the blast fan 12. The airflow paths are guided by the airflow-guiding structure 70, which includes ventilation channels 75.

A power tool, such as a disc grinder 1, comprises the driving motor 10, the continuously variable transmission traction drive 30, the blast fan 12 and the airflow-guiding structure 70. The continuously variable transmission traction drive 30 changes the number of rotations from the driving motor 10 and outputs the changed rotation. The driving motor rotates the blast fan 12. The blast fan 12 cools the driving motor 10 by sending airflow to the driving motor 10. The airflow-guiding structure 70 guides the airflow to the continuously variable transmission traction drive 30.

Therefore the blast fan 12 can cool not only the driving motor 10 but also the continuously variable transmission traction drive 30.

The disc grinder 1 comprises the accommodating case 71 that holds the continuously variable transmission traction drive 30. The outer surface of the accommodating case 71 preferably faces the airflow-guiding structure 70. Therefore, the continuously variable transmission traction drive 30 is cooled by the airflow sent by the blast fan 12 through the accommodating case 71.

The accommodating case 71 prevents a lubricant or the like provided in the continuously variable transmission traction drive 30 from leaking outside. The lubricant is, for example, traction grease or the like, provided to enhance the rolling contact of rollers that press against each other in the continuously variable transmission traction drive 30. Therefore, the accommodating case 71 prevents the lubricant disposed between the rollers (for example, traction grease) from leaking outside. Further, the accommodating case 71 guides the air to cool the continuously variable transmission traction drive 30. The blast fan 12 sends cooling air to the continuously variable transmission traction drive 30 to prevent overheating.

The disc grinder 1 preferably also has fins 73. The fins 73 may protrude outward from the outer surface of the accommodating case 71. The accommodating case 71 is preferably made of metal. Therefore, the accommodating case 71 has high heat conductivity because it is made of metal. The continuously variable transmission traction drive 30 can be effectively cooled by the accommodating case 71. The fins 73 increase the contact area between the accommodating case 71 and the airflow that cools the continuously variable transmission traction drive 30. In this way, the thermal conductivity between the accommodating case 71 and the airflow increases. Accordingly, the continuously variable transmission traction drive 30 can be effectively cooled by the accommodating case 71.

As shown in FIG. 4, the fins 73 function like ribs for supporting the accommodating case 71 and the transmission case 3a against each other. Accordingly, the rigidity of the inside of the reduction case 3a is high and the likelihood of damage to the disc grinder is reduced should it be impact another object or surface.

The disc grinder 1 typically has a transmission case 3a covering the accommodating case 71. The transmission case 3a may be made of resin. Therefore, when the continuously variable transmission traction drive 30 is heated, a transmission case 3a made of resin can serve to reduce the amount of heat escaping to the outside of the accommodating case 71. Accordingly, a user can hold the outer portion of the mechanism main body 300 with a hand even if the mechanism main body 300 is heated.

The airflow-guiding structure 70 includes the ventilation channels 75. The ventilation channels 75 are disposed between the accommodating case 71 and the transmission case 3a. Accordingly, the airflow sent by the blast fan 12 can pass through the ventilation channels 75. The airflow can receive the heat generated between the accommodating case 71 and the transmission case 3a. Therefore, when the mechanism main body 300 located in the accommodating case 71 is heated, the heat is absorbed by the airflow passing through the ventilation channels 75. Therefore, it is possible to suppress the heat from being conducted from the mechanism main body 300 to the outside of the outer case.

The airflow-guiding structure is preferably disposed in the previously described 180 degrees or more, of the 360 degree range, around the outer circumference of the accommodating case 71. Accordingly, the continuously variable transmission traction drive 30 can be cooled through the accommodating case 71 in the range of the half or more of the outer circumference of the accommodating case 71. Accordingly, it is possible to efficiently cool the continuously variable transmission traction drive 30.

While the invention has been described with reference to specific configurations, it will be apparent to those skilled in the art that many alternatives, modifications and variations may be made without departing from the scope of the present invention. Accordingly, embodiments of the present invention are intended to embrace all such alternatives, modifications and variations that may fall within the spirit and scope of the appended claims. For example, embodiments of the present invention should not be limited to the representative configurations, but may be modified, for example, as described below.

The blast fan 12 may be a centrifugal fan or an axial fan. The disc grinder 1 may have multiple exhaust ports or just a single exhaust port. The exhaust direction of a single exhaust port is preferably in the upward direction. In this way, exhaust air does not inadvertently blow dust, dirt or other objects existing on a lower surface upwards and towards the user of the disc grinder 1.

The airflow-guiding structure may include ventilation channels 75 or may be implemented in another configuration including other ventilation channels.

The power tool may be a disc grinder or other appropriate power tool, such as a screw-tightening machine or an electric drill for boring. The power driving source may be an electric motor, as described above, or may be an air motor. The power tool may be an electric tool or an air tool.

This invention claims:

1. A power tool comprising:
a driving motor;
a continuously variable transmission traction drive configured to change the number of rotations from the driving motor and output the changed number of rotations;
a blast fan rotated by the driving motor to cool the driving motor by sending airflow to the driving motor; and
an airflow-guiding structure configured to guide the airflow to the continuously variable transmission traction drive.

2. The power tool of claim 1 further comprising:
an accommodating case configured to accommodate the continuously variable transmission traction drive; and
an outer surface of the accommodating case facing the airflow-guiding structure.

3. The power tool of claim 2 further comprising a fin protruding outward from the outer surface of the accommodating case, wherein the accommodating case is made of metal.

4. The power tool of claim 2 further comprising a transmission case covering the accommodating case, wherein the transmission case is made of resin.

5. The power tool of claim 4 further comprising a ventilation channel in the airflow-guiding structure disposed between the accommodating case and the transmission case to pass the airflow.

6. The power tool of claim 2, wherein the airflow-guiding structure is disposed in a range of a total of 180 degrees or more of a range of 360 degrees around an outer circumference of the accommodating case.
